(19) United States
(12) Patent Application Publication
(10) Pub. No.: US 2015/0377677 A1
(43) Pub. Date: Dec. 31, 2015

(54) OPTICAL REMOTE SENSING SYSTEM FOR PROCESS ENGINEERING CONTROL

(71) Applicant: ANDRITZ OY, Helsinki (FI)

(72) Inventors: Jussi TENHUNEN, Kuopio (FI); Oulu SIIKANEN, Oulu (FI); Juha KOSTAMOVAARA, Helsinki (FI)

(73) Assignee: ANDRITZ OY, Helsinki (FI)

(21) Appl. No.: 14/769,681

(22) PCT Filed: Feb. 20, 2014
(86) PCT No.: PCT/IB2014/059130

§ 371 Date: Aug. 21, 2015

(30) Foreign Application Priority Data
Feb. 22, 2013 (FI) 20135159

(51) Int. Cl. G01F 17/00; G01S 17/10; G01S 7/481; G01S 17/89

(52) U.S. Cl. CPC G01F 17/00; G01S 17/89; G01S 17/10; G01S 7/4817

(57) ABSTRACT

The invention concerns an optical remote sensing system, comprising a reaction chamber adapted to host a chemical reaction in the shape of a scattering turbid atmosphere inside the reaction chamber. An optical active sensor is used to detect the three dimensional structure of an accumulation, such as a heap, inside the reaction chamber, suggesting various measurement methods.

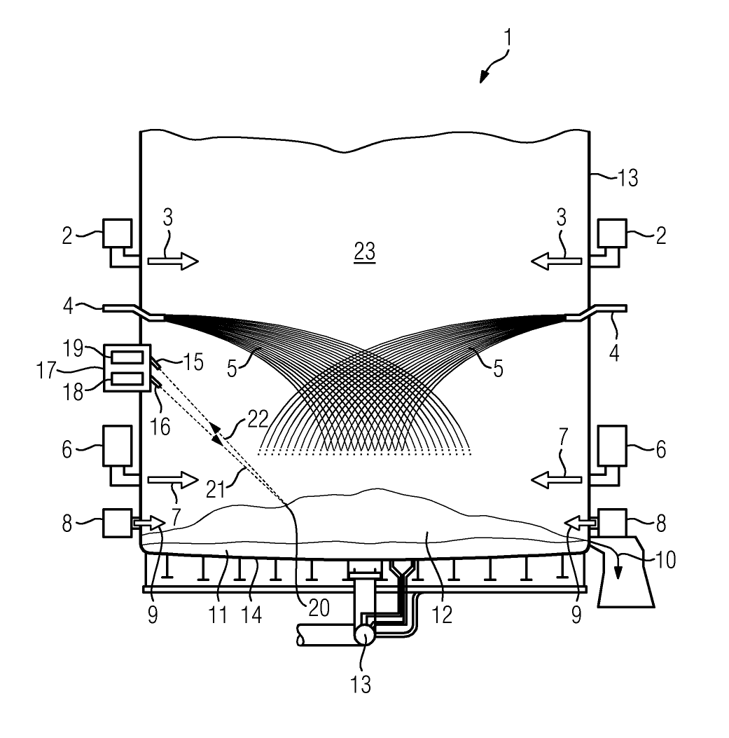

### TECHNICAL FIELD

Process engineering has become a major field in modern plant technology. In particular, chemical and power producing industrial plants use chemical processes in large scales to meet the growing needs of civilization. Therefore research institutions strive to improve production processes by making them more effective, cheaper, safer or more environmentally friendly.

### BACKGROUND ART

In order to keep a chemical reaction running, a lot of parameters need to be monitored and controlled. With the number of parameters the complexity of process control increases. Usually a chemical reaction chamber, boiler or furnace or similar is employed to host the chemical process. The parameters may consist of the exact amounts of chemical substances supplied to the process or the temperature or pressure, etc.

The control of an industrial chemical process does not only require the setting of the parameters to certain values, but also the monitoring of the process in order to understand its current state and to recognize possible problems. In many reaction chambers the chemical process needs to be carried out in a scattering turbid atmosphere. These usually go along with high temperatures and pressures. As long as the distribution of a reactant, chemical by-product or whatever chemical substance or mixture of interest within said atmosphere is reasonably even, the detection is not too problematic, since it can be carried out close to the inside walls of the reaction chamber, assuming that the measurement would not lead to any other value if it was carried out, for instance, right in the center of the reaction chamber.

Unfortunately there are substances, by-products, etc. that are not evenly distributed within the scattering turbid atmosphere of the reaction chamber. Such substances are, for instance, sediments, accumulations, heaps and chars of whatever substance or mixture. They settle somewhere (usually at the bottom of the chamber) and are not detectable since the scattering turbid atmosphere is blocking the view upon them.

In the Kraft pulp production process, a fibrous material, most commonly wood chips, is broken down into pulp in a digester under pressure in a steam-heated aqueous solution of sodium hydroxide and sodium sulphide, called white liquor. After cooking in the digester, the pulp is separated from the residual liquid called black liquor.

Said black liquor is dried in the evaporation plant to 55-85% dry solids concentration (concentrated) and then black liquor is sprayed into the furnace of the recovery boiler, and burned (in a recovery boiler) to recover cooking chemicals and to generate steam, which is used in the pulp mill for power generation, for pulp cooking and drying, for black liquor drying, and for other energy needs.

The inorganic material in black liquor is recovered in the recovery boiler for reuse in the cooking process. This recovery requires special, reducing atmosphere in the lower furnace. Typically this is achieved by creating a char bed on the floor of the furnace. The shape and size of the char bed depends on the boiler design, but it can be some meters high in the highest place, calculated from the smelt overflow height. The inorganics are taken out of the recovery boiler furnace as molten smelt and, the main components of which smelt are typically Na₂CO₃ and Na₂S, with smaller amounts of potassium based compounds. Smaller amounts of non-process elements also flow out of the furnace entrained in the smelt.

Liquor is sprayed into the furnace from several locations, which are called ports. The ports are typically located at one level, called liquor feed level, but there can also be more levels to meet special requirements. When liquor is sprayed into the furnace, it heats up due to hot atmosphere, which results in drying and pyrolysis. In the pyrolysis phase the organic structure of black liquor is destroyed; part of the material will end up as pyrolysis gas into the furnace atmosphere, and part of the material continues its travel as char. Both material streams ignite and burn, until the organic material has been consumed. Only a very small part of the original organic material in black liquor leaves the furnace unburned in modern recovery boilers. Depending on the original droplet size, char burns totally in flight or ends up into the char bed and onto furnace walls.

In modern recovery boilers drying, pyrolysis and combustion on furnace walls is to be minimized. The char bed is formed of burning liquor droplets, burning char and inorganic material, in which sulphur compounds are reacting from oxidized form to reduced form. This reduction requires carbon to take place, and thus the char bed control is essential for achieving good reduction efficiency. The reduction efficiency expresses which portion of the total sulphur in the smelt flowing out of the furnace is in the form of Na₂S+K₂S. Typically this is over 90%. When reduction is good the reduction efficiency is over 95-96%.

Small liquor droplets are also generated during liquor spraying, and these droplets dry, pyrolyze and burn in flight. Then very easily, due to the combustion atmosphere passed in the upper furnace, the droplets, which finally enter the floor area of the furnace, contain oxidized sulphur. Then again carbon is needed for sulphur reduction. Good total reduction requires good carbon coverage over the whole floor. The reactions between carbon and oxidized sulphur, the most important, Na₂SO₄ as an example, are strongly temperature-dependent and require energy. Thus only a relatively thin surface layer on the surface of the char bed is active, which means that the char bed does not have to be high.

Controlling possibilities and characteristics of liquor spraying and different combustion air feeds, together with the reduction characteristics, dictate in practice the shape of the char bed. If the bed grows too big, there is a risk of bed fall into airports, typically into primary airports, and a risk of smelt rushes via smelt spouts into the dissolving tank or into dissolving tanks.

An effective burning process requires that the char bed can be controlled reliably. Therefore, a need to monitor and control the size and shape of the char bed in a kraft recovery system has been recognized for many years.

Gas temperatures in the furnace range typically from 100 -150 degree C. in incoming air and liquor to 1200-1400 degree C. in the hottest areas of the furnace, for instance in the area, where tertiary air is fed into the furnace, or where final combustion takes place. On the char bed the surface temperature is typically 900-1200 degree C. Smelt flows out of the furnace typically at a temperature of 800-900 degree C. The clean walls of the furnace have a temperature of 250-400 degree C., depending on the pressure of the boiler and on the observation point. Deposition takes typically place on furnace walls, and raises the surface temperature of the deposit closer to temperatures in the gas phase and in the char bed.

All the surfaces emit thermal radiation, which is basically continuous, but changes in radiation properties, such as emissivity, as a function of temperature cause that the radiation intensity distribution does not follow Planck's law. Naturally, when the dependency of the radiation properties on temperature and composition is known, proper correction factors can be generated to fit the measured intensities on several wavelengths to the intensity distribution curve according to the Planck's radiation law, to estimate the surface temperature of the radiating surface.

Gases, liquids and solids in the furnace gas atmosphere radiate as well, but this radiation is concentrated, at least partly, to spectrums.

The small particles in the furnace radiate and scatter incoming radiation, complicating the system. Thus the radiation phenomena in the furnace are very complex. The key factor which enables imaging the char bed from the surrounding hot gas atmosphere with vapors and particles is to receive radiation information from the char bed, which is not excessively influenced by the surrounding atmosphere.

It is known to use a TV camera mounted in a special port or into an air inlet port to monitor the bed, i.e. the TV camera continuously scans the bed and a TV set provides a picture in the control room so that the operator may use this picture to control the furnace.

One example is a Kraft recovery boiler disclosed in EP 0761 871 A1, which is used in the Kraft pulping process. The boiler converts organic residues to energy and simultaneously recovers inorganic cooking chemicals. At the lower part of the boiler a reduction of oxidized sulfur components takes place, which allows their withdrawal as smelt out of the boiler.

The settling heap on the bottom of the boiler cannot be seen or checked otherwise from outside the boiler. However, the knowledge where and how much already settled is extremely important for the control of the process as described above.

In the past several techniques were used to monitor the floor of the furnace inside a boiler. At present, the systems for the measurements of the shape of a heap (char bed) of a chemical recovery boiler are inadequate. The conditions for the measurement are demanding, for example, because of a high temperature and large dimensions of the furnace of the boiler.

All solutions of the prior art suffer the optical characteristics of the scattering turbid atmosphere, which makes the detection complicated or expensive or both.

### DISCLOSURE OF INVENTION

The aim of the invention is to supply best information regarding the location and dimensions of accumulations in reaction chambers of scattering turbulent atmospheres in order to improve the control of the reaction process and eliminate disadvantges of known location systems.

Further, an object is to provide an improved system for monitoring a char bed of a chemical recovery boiler.

The invention teaches an optical remote sensing system, comprising:
a reaction chamber adapted to host a chemical reaction in the shape of a scattering turbid atmosphere inside the reaction chamber of a chemical recovery boiler;
a detector for a detection of probing light at a predetermined wavelength or a predetermined wavelength interval; and
a light source emitting the probing light at the predetermined wavelength or the predetermined wavelength interval, the probing light of the light source forming a probing light beam, whereas the probing light beam is directed onto at least one element inside the reaction chamber and reflected or backscattered by the at least one element into the detector.

The predetermination of the wavelength indicates a selection before the employment of the system in order to find out at which wavelength or wavelength interval of light the active sensor principle can be performed best. The predetermination of the wavelength is a selection of a wavelength or a wavelength interval within the mid-infrared region (MIR) from 5 to 40 microns or in the near infrared region (NIR). Advantageously, in the mid-infrared region the blackbody radiation is non-existent or sufficiently low in intensity. There is also a broad wavelength range to choose from allowing a great number of laser sources. Also, wavelength-tunable laser sources can advantageously deployed to avoid absorption bands in the MIR and tend to be inexpensive. The NIR region is advantageous in the chemical recovery boiler, where the scattering is massive.

Firstly, the detector and the light source need to work as the same wavelength or at wavelength interval, which need to have a sufficient overlap for detection.

Secondly, the predetermination may intend to avoid absorption lines of the scattering turbid atmosphere. This minimizes optical losses of the probing light within the reaction chamber and hence assures high signal strength of the detected probing light.

Thirdly, it may be important to take blackbody radiation of the atmosphere into account, which makes the wavelength choice dependent on the temperature of the scattering turbid atmosphere.

Advantageously the light source operates in the mid-infrared region (MIR) at wavelengths from 5 to 40 microns or in the near-infrared region (NIR), in order to avoid the high irradiance at lower wavelength due to the blackbody radiation. As an alternative to using the mid-infrared region (MIR) radiation, or in addition to it, a part of the visible spectrum (for example, from approx. 500 nm to longer wavelengths, up to 780 nm) and/or near-infrared (NIR) radiation can be used. The power of the emitted laser radiation must exceed the black body radiation power emitted by the char bed. As an example, the wavelength 532 nm can be obtained with a microchip laser. In the NIR region the wavelengths of 1.6 μm, 2.2 μm and 3.9 μare known to have strong emission in a boiler (Saviharju et al.“THREE DIMENSIONAL CHAR BED IMAGING FOR NUMERICAL SIMULATION FEEDBACK”, pp. 469 to 472, Proceedings of the 2007 International Chemical Recovery Conference).

Fourthly, the scattering coefficient of the atmosphere also depends on the wavelength and therefore needs to be taken into account as well.

The probing light indicates the usage of the light to recover a distance of one or more elements of a target area inside the reaction chamber in respect to one or more reference points, in particular to the location of the detector and/or the light source. The elements may be part of a heap, a char or any other accumulation inside the reaction chamber. The distance may also be evaluated as a time difference of some reference light in comparison with the reflected probing light.

The mentioned accumulations may occur typically on the bottom of the reaction chamber, but can also appear in corners or inlets or other less turbulent areas of the chamber. The accumulations consist of a multiple number of elements, whereas one element might be any kind of particle contributing to the accumulation.

The detector has the function to convert the probing light into an analog or eventually a digital signal, which can be analyzed by itself or in comparison to another signal originating from the reference light of a reference light beam, which has not been reflected by an element inside the chamber and ideally originates from the same light source like the probing light.

The combined usage of a light source and a light detector makes the remote sensing system use the principle of an active sensor. The system does not rely on the light, which is supplied by the scattering turbid atmosphere, but employs its own light to probe elements of the accumulations in order to obtain information about their location.

Importantly the information of the dimensions of the accumulation may serve to improve the performance in the reaction chamber. The accumulation could constitute a reaction component or by-product or similar, whose amount can be calculated or estimated by the optical remote sensing system giving a picture on the efficiency of the ongoing chemical reaction. Therefore steps can be taken to improve performance of the reaction chamber.

If the accumulation, for example, constitutes a heap of an undesired byproduct, it is evident that the reaction ingredients are wasted up to a certain degree and that measures to reduce the heap will allow a better use of the resources. Furthermore, the service intervals of the reaction chamber are reduced since the accumulations can be avoided and do not need to be removed by cleaning up the accumulations involving a costly interruption of the reaction, in particular, if the reaction chamber is a boiler or a furnace of an industrial production plant.

Advantageously, the detector and the light source are integrated into a single device. Like this the system can be quickly installed, by equipping the reaction chamber, which in many applications is not movable due to its dimensions, directly with such a single device. Such a single device might be called an active sensor, because it does not depend on light coming from the scattering turbid atmosphere. Instead it is adapted to analyze its own light originating from its light source, whereby the light is used as probing light, intended to enter the scattering turbid atmosphere and retrieve information about an accumulation inside the reaction chamber.

Ideally the active sensor further contains optical components to facilitate the handling of light inside the active sensor, such as dielectric, silver or gold mirrors, optical lenses, optical filters and the like. Such components might be used to direct the probing light through the first passage and also to receive the reflected probing light though the second passage of the reaction chamber.

The active sensor may also have an integrated or externally connectable analysis unit, which analyzes the signal or the signals from the detector. It may also calculate the distance of one or more elements of the accumulation in respect to a reference point. Ideally the analysis unit includes a graphic display generating an image of the accumulation.

The reaction chamber has at least one optical passage. This passage is transparent for the predetermined wavelength or predetermined wavelength interval. This might be a simple opening, in case some leakage of the substances within the turbid atmosphere is acceptable. Alternatively, the optical passage consists of a solid, transparent material. The transparency should be given for the predetermined wavelength or the predetermined wavelength interval. Secondly the solid, transparent material should withstand the conditions imposed by the scattering turbid atmosphere, such as high temperatures or aggressive chemicals. Like this, the probing light can easily enter and leave the reaction chamber, without any substances leaking out.

Optionally the probing light beam of the light source enters the reaction chamber through a first optical passage and leaves the reaction chamber after the reflection by the element through a second optical passage assigned to the detector. Like this a reasonable flexibility in terms of a broader choice of implementations is guaranteed. The active sensor may not need to be integrated in a single device. Also the reflection angle of the probing light does not need to be close to 180 degrees. Hence the location of the light source and the location of the detector does not need to be the same nor need they be close to each other. Like this constructive features of the reaction chamber can be taken into account.

However, if the location of the light source and the one of the detector can be the same, the first optical passage and second optical passage may be the same optical passage. It might even be that the beams of the probing light before and after reflection inside the reaction chamber are collinear to each other propagating in opposite directions. The separation at the detector's end could be realized using a beam splitter or even a polarizing beam splitter when using polarized probing light, like the light originating from a laser light source.

A possible analysis unit would analyze the detector output depending on the employed measurement method. Therefore the sensing system may further comprise time measurement means measuring the probing light traveling time from a first reference point located outside the reaction chamber, the first reference point being passed by the probing light before entering the reaction chamber, and a second reference point also located outside the reaction chamber, the second reference point being passed after the reflection of the probing light by the at least one element inside the reaction chamber. The measurement means measure the traveling time of the probing light between the both reference points. In the literature the traveling time is often referred to as the “time of flight”.

Interestingly, the first and second reference point can be the same reference point. In general, the first reference point may be closely located to the light source and the second reference point closely located to the detector. In case some light from the light source is used as reference light, being guided from the light source to the detector, the same reference point may be the point, where the probing light is separated from the reference light. After returning from the reflection inside the reaction chamber the probing light returns to the said same reference point and follows the light path of the reference light towards the detector. The time difference of the probing and the reference light then being detected corresponds to the distance of said reference point to the element.

The reflected probing light beam can be analyzed in reference to a reference light beam or the detected signals of both light beams are analyzed in reference to each other. This might be carried out in an optical correlation of the probing light and the reference light. For example, if the probing light and the reference light consist of light pulses, their temporal overlap can be evaluated by a correlation setup, whereby the detector detects correlation light of another wavelength or another wavelength interval being an indicator of the temporal overlap of the probing pulse and the reference pulse. Therefore the strength of the correlation signal would indicate the temporal separation of both pulses and therefore allows the calculation of the distance of the corresponding element in the reaction chamber.

Another measurement method may also be used taking into account that the probing light returning from the reaction chamber might be very low in power, due to absorptions and/or scattering inside the reaction chamber. For example, only a probing light beam might be used (without a reference light beam), whereby irradiance arriving after a recorded time period after directing the probing pulse into the reaction chamber is accounted for. The system is recording the reflected probing light, which is detected like an echo. If this echo is very low in power a so-called lock-in detection might be useful, where a chopper is used to chop the light into pulses, unless the light source does not supply light pulses already. Using the chopping rate or the repetition rate of the light source such reflected or backscattered probing light may by recorded several times and the counts may be integrated over several light pulses arriving and thereby eliminating the noise originating from the radiation of the scattering turbid atmosphere.

Monitoring efficiency increases if the remote sensing system further comprises light beam direction means to measure the probing light traveling times for at least two elements inside the reaction chamber, the elements being located in different directions in respect to the first reference point. By a simple replacement or adjustment of one of the elements in the light path of the probing light it can be directed onto another element in the reaction chamber. Like this two places can be tested for accumulations, which in many applications might already be sufficient to carry out an analysis, in particular, if additional information is known. Such information may be the typical way an accumulation takes shape inside the reaction chamber. If the distribution was, for example, nearly Gaussian distributed—or any other previously known distribution, then probing the distance of elements at representative locations will be sufficient to retrieve the entire three-dimensional distribution of the accumulation.

Advantageously, the light beam directing means are implemented as light beam scanning means to scan an inside target area of the reaction chamber by changing the direction of the probing light beam consecutively and thereby sweeping the probing light beam over an inside target area of the reaction chamber probing a multiple of elements located in the inside target area. Ideally, the area may be divided into lines and columns, thereby defining a two dimensional array D(x,y) of distances from the first reference point of the respectively tested element. If the distances are plotted over the x,y plane as z-values a three dimensional image of the accumulation can be retrieved.

If the light source is chosen to be a laser, particularly a gas laser, a fiber laser, a semiconductor laser or a semiconductor laser diode, it may include specific advantages. A gas laser may supply high power in case the transmission through the scattering turbid atmosphere could only be absorbed at very high absorption levels. Also continuous wave fiber lasers have high output powers. Both lasers may require a chopper or modulator setup in order to turn the continuous optical output into pulsed probing light. Semiconductor lasers may be more flexible on the wavelength and there are some sources, which can be tuned to favorable wavelengths or wavelength intervals. With a laser diode the system would be very easy to use and to handle, since the light source would not occupy much space. Therefore the laser diode would be ideal for realizing the earlier mentioned single device active sensor.

The meaning of laser source includes naturally all devices making use of light amplification by stimulated emission radiation. However, also such devices are included which produce light of laser quality without falling under said definition, such as nonlinear optical devices, optical parametric oscillators, harmonic amplifiers or the like.

Another advantage of using probing light from a laser is the possible usage of its polarization. In particular, if the reflected probe light pulse would be analyzed for possible shifts in polarization probably more information about the accumulations could be found.

Advantageously the laser is adapted to emit pulsed probing light. Such a temporal resolution can be used to reduce negative influences of the backscattering from the scattering turbid atmosphere. For example, when a lock-in amplifier setup is used, all the detection noise resulting from scattered light from the atmosphere arriving between pulses can be disregarded. Also, since the optical energy is concentrated in the pulse, a better detection of the signal after passing the turbid atmosphere is possible.

Advantageously, the probing light beam consists of light pulses having a temporal duration of 100 picoseconds up to 10 nanoseconds, in particular 2 to 5 nanoseconds. Such pulses easily reach a peak power of several kilowatts, allowing high losses due to scattering or absorption in the turbid atmosphere. Also correlation experiments are easy to perform if a reference beam pulse is used.

The reaction chamber may be a container of various sizes. The reaction chamber might be a furnace, a boiler, a chemical reactor or a similar container. In fact, the system functions well with any container hosting an atmosphere, which cannot be looked through directly. This obstacle might be due to the type of atmosphere, but can also be due to the size of the reaction chamber. For example, there might be absorbing, turbid atmospheres, which are still reasonably transparent for small laboratory sized reaction chambers, but not for industrial furnaces.

The at least one element may be a droplet, an element of a heap, an element of a char or an element of an accumulation of a chemical substance or chemical mixture inside of the reaction chamber. Generally speaking, the element is defined as the smallest unit of a three dimensional structure of an accumulation capable of reflecting or backscattering the probing light.

In a preferred embodiment a single photon counting method is used to record the flight times of individually detected photons. For example, a “Photon counting mode” (time correlated single photon counting, TCSPC) may be implemented as one possible single photon counting method. Single photons are detected to form the “histogram” of the photon flight time, where the flight times of individually detected photons are recorded. It is advantageous to use a single photon counting method in Geiger mode.

An advantageauos embodiment is a chemical recovery boiler, in particular a Kraft recovery boiler, with a system according to the invention. Any chemical recovery boiler suffers the problem that the turbulent atmosphere disallows the close watch and control of any accumulation on the bottom of the boiler's furnace. The invention is not limited to the Kraft boiler and can be deployed advantageously with any chemical recovery boiler. In the following FIGURE description the invention is illustrated by describing an embodiment of the Kraft boiler.

### DESCRIPTION OF THE DRAWING

In the FIGURE the lower part of a Kraft boiler is shown in a cross sectional view. The heat is supplied by the hearth 13 under the bottom 14 of the furnace 1. The temperature within the furnace 1 reaches some thousand degrees leading to a scattering turpid and strongly light emitting atmosphere 23 (blackbody radiation). In other words, the conditions within the furnace 1 are very severe.

At the bottom 14 of the furnace 1 an accumulation in the shape of a heap 12 (char bed) is growing during the process. It is composed of recovered cooking chemicals. The so called smelt 11 is withdrawn from the furnace 1 through the smelt outlet 10. The dimensions and shape of the heap 12 are of high interest for the control of the chemical process inside the furnace 1, because it is one of the most crucial parameters of the Kraft recovery process.

The optical remote sensing system according to the invention teaches an advantageous solution for the measurement of its dimensions and shape inside the furnace having extremely severe conditions.

The furnace 1 bears several injection ports to intoduce the required chemical ingredients, such as black liquor 5 and the primary, secondary, tertiary air 9,7,3.

The range finding measurement according to the invention is based on the fact that speed of light is constant in the scattering turbid atmosphere 23. Thus, if the time difference between the emitted laser pulse (from the source) and the received backscattered/reflected signal from the element 20 in the inside target areas is measured, one can calculate the distance between the one element in the target inside area and a first reference point. This distance being basically the distance between the active sensor and the probed element.

In the FIGURE the active sensor 17 is a mobile device and can be placed and/or connected to the outside of the furnace 1. The probing light 21 enters the furnace 1 trough the first passage 16, travels to the element 20 of the targeted area and is reflected by the element 20. In the context of the invention the terms “backscattered by the element” and “reflected by the element” are used synonymously. After the reflection the probing light 22, it returns through the second passage 15 in order to be directed into the detector 19. Ideally the first and second passage 15,16 might be realized by a single opening in the furnace wall.

The three-dimensional shape of the heap 12 (or other accumulated objects inside the furnace 1) can be retrieved by scanning the probing light 21 over the target area surface repeating the distance/range measurement for a multiple of elements 20. The reflected or scattered probing light is detected and a distance for each element 20 in that target area is recorded. The measured distances can be displayed to give a three-dimensional image of the target area inside the furnace 1. Ideally a screen is used to display the three-dimensional shape of the heap 12. The analysis unit may be or at least comprise a computer with such a screen. This system can be used to monitor and control the char bed in the chemical recovery boiler.

Measurement accuracies of a few millimeters per second can be achieved at distances of up to tens of meters, when the following measurement techniques are employed. There are two cost effective measurement options, the “linear mode” or the “photon counting” for the laser range finding technique.

The “linear mode” option detects the photon flux of the reflected probing light in the detector, thereby converting the flux into an analog electrical signal. It is the cheaper option and it is more readily avaliable, but it is also more limited by the heavy backskatter resulting from the evenly distributed particles of the turbid atmosphere 23 inside the furnace 1. Since the photons create an analog signal it is possible to trigger (for example with an oscillocope) upon the rising edge of the signal. This might be done with a reference beam pulse, which supplies a clear and unpertubed signal for analog triggering. The backscattered probe light pulse appears in a defined temporal delay in respect to the reference pulse, which can be used to determine the distance to the element 20. In other words, just one time delay between the pulses is recorded. The triggering can also be done using the rising edge of the reflected pulse signal itself without any reference pulse, whereas the reflected pulse signal is not as strong due to the losses in the furnace 1 and it more likely to be missed if it falls under a minimum trigger theshold.

Alternatively a “Photon counting mode” (time correlated single photon counting, TCSPC) can be used. It means that single photons are detected to form the “histogram” of the photon flight time, where the flight times of individually detected photons are recorded and the “steplike” increase of the reflected probing light resulting from the well defined element 20 can be resolved from the “smooth” baseline formed by the evenly distributed scattering particles in the turbid atmosphere 23. It is advantageous to use a single photon counting method in Geiger mode.

Furthermore, the selection of the predetermined wavelength is another issue of high importance, since the scattering coefficient of the particles, emission of the particles, emission lines of the gases, laser cost and power, detector noise etc. vary with the wavelength. The laser source operates in the mid-infrared region (MIR) at wavelengths from 5 to 40 microns or in the near-infrared region.

The applicant has experience using a visible or mid-infrared high speed camera to obtain an image from the heap 12 in the FIGURE. However, the results left much to improve and therefore gave rise to the conclusion that in the Kraft recovery boiler or in other similar environments, the use of an active sensor laser range finder technique to measure the three-dimensional shape of the heap 12 is more advantageous. This holds particularly true if the probing light is sent and recieved through a single passage, set forth as an opening in the wall of the furnace 1. The advantages over the passive camera technology are as follows:
with the use of a narrowband pulsed laser light source 18 having a wavelength interval (spectrum) of a few nanometers or less and a peak power of over a kilowatt, the resulting irradiance at the targeted areas can rise over the thermal blackbody radiation and line emissions of the furnace 1.
the “time of flight” principle provides directly the three-dimensional shape of the heap 12 from ideally a single opening, making sure that the Kraft recovery process is not impaired by possible leakages.
the temporal resolution using short pulses at a specified repetition rate can be used effectively to discriminate the high backscattering from the turbid atmosphere 23 of the furnace 1.
the signal-to-noise ratio is further improved due to the laser light source 18 operating at wavelengths (5 to 40 microns) far from the center wavelength of the blackbody radiation of the scattering turbid atmosphere 23.
the optical remote sensing system according to the invention causes one order of magnitude less costs than the passive approach using a high speed mid-infrared (MIR) or visible (VIS) camera technology.

### SUMMARY

The invention concerns an optical remote sensing system, comprising a reaction chamber 1 adapted to host a chemical reaction in the shape of a scattering turbid atmosphere 23 inside the reaction chamber 1. An optical active sensor 17 is used to detect the three dimensional structure of an accumulation, such as a heap 12, inside the reaction chamber 1, suggesting various measurement methods.

### REFERENCE SINGS

1 furnace

2 tertiary air injection port

3 tertiary air

4 black liquor injection port

5 black liquor

6 secondary air injection port

7 secondary air

8 primary air injection port

9 primary air

10 smelt outlet

11 smelt

12 heap

13 hearth

14 boiler bottom

15 second optical passage

16 first optical passage

17 active sensor

18 light source

19 detector

20 element

21 probing light before reflection

22 probing light after reflection

23 scattering trubid atmosphere

1. An optical remote sensing system comprising
a reaction chamber in a chemical recover boiler, the reaction chamber configured to host a chemical reaction occurring in a scattering turbid atmosphere inside the reaction chamber;
a detector configured to detect a probing light at a predetermined wavelength or a predetermined wavelength interval; and
a light source configured to emit the probing light is and direct the probing light onto at least one element inside the reaction chamber, wherein the probing light detected by the detector is reflected or backscattered by the at least one element towards the detector.

2. The system according to claim 1, wherein the detector and the light source are integrated into a single device.

3. The system according to claim 1, wherein the reaction chamber includes an optical passage being transparent at the predetermined wavelength or predetermined wavelength interval.

4. The system according to claim 1, wherein the probing light beam from the light source enters the reaction chamber through a first optical passage and the reflected or backscattered probing light leaves the reaction chamber through a second optical passage in optical communication with the detector, whereby the first optical passage and second optical passage are in an optical passage.

5. The system according to claim 1, further comprises a time measurement device configured to measure a traveling time of the probing light from a first reference point located outside the reaction chamber, the first reference point being passed by the probing light before entering the reaction chamber, and a second reference point located outside the reaction chamber, the second reference point being passed by the probing light after the reflection of the probing light by the at least one element inside the reaction chamber.

6. The system according to claim 5, wherein the first reference point and the second reference point are at the same location.

7. The system according to claim 5, further comprising an analyzer configured to analyze the probing light detected by the detector in reference to a reference light beam.

8. The system according to claim 5, wherein the system further comprises a light beam direction measurement device configured to measure the probing light traveling times for at least two elements inside the reaction chamber, the elements being located along different directions in respect to the first reference point.

9. The system according to claim 8, wherein the light beam direction measurement device includes a light beam scanning scanner configured to scan an target area in the reaction chamber by changing a direction of the probing light beam to sweep probing light beam over the target area and thereby probe multiple of elements located in the inside target area.

10. The system according to claim 1, wherein the light source is a laser.

11. The system according to claim 10, wherein the laser is configured to emit a pulsed probing light.

12. The system according to claim 11, wherein the probing light includes light pulses having a temporal duration of 100 picoseconds to 10 nanoseconds.

13. The system according to claim 1, wherein the reaction chamber is one of a furnace, a boiler, and a chemical reactor.

14. The system according to claim 1, wherein the at least one element is at least one of a droplet, an element of a heap, an element of a char or an element of an accumulation of a chemical substance or chemical mixture inside of the reaction chamber.

15. The system according to claim 1 wherein the light source operates in a mid-infrared region (MIR) at wavelengths from 5 to 40 microns or in a near-infrared region (NIR).

16. The system according to claim 1, wherein further comprising a single photon counting device configured to record flight times of individually detected photons of the probing light.

17. A chemical recovery boiler with the system according to claim 1.

18. A method for optical remote sensing comprising:
generating a probing light at a certain wavelength or interval of wavelenthgs;
directing the probing light to a target in a reaction chamber of a chemical recover boiler, wherein the reaction chamber contains a chemical reaction occurring in a scattering turbid atmosphere and the probing light passes through the scattering turbid atmosphere;
reflecting the probing light from the target;
detecting the reflected probing light;
calculating a distance between the target and a certain location based on the reflected probing light, and
presenting the calculated distance.

19. The method of claim 18 wherein directing the probing light further includes sweeping the probing ling across the target, and the calculation of the distance includes calculation of distances between the certain location and locations on the target, and the presentation includes displaying a three-dimensional image of a shape of the target, wherein the method further comprises generating the three-dimensional image based on the calculated distances.
